(19) United States
(12) Patent Application Publication
(10) Pub. No.: US 2016/0132812 A1
(43) Pub. Date: May 12, 2016

(54) MULTI-CHAT MONITORING & AUDITING SYSTEM

(71) Applicant: ZeniMax Media Inc., Rockville, MD (US)

(72) Inventors: Boyd Beasley, Hunt Valley, MD (US); James Whitehouse, Hunt Valley, MD (US)

(21) Appl. No.: 14/695,881

(22) Filed: Apr. 24, 2015

Related U.S. Application Data
(60) Provisional application No. 62/121,137, filed on Feb. 26, 2015.
(60) Provisional application No. 62/078,019, filed on Nov. 11, 2014.

(51) Int. Cl. G06Q 10/06; H04L 29/06; H04L 12/58; G06Q 30/00

(52) U.S. Cl. CPC G06Q 10/06393; G06Q 30/016; H04L 65/403; H04L 51/046; H04L 65/1093

(57) ABSTRACT

A multi-chat monitoring and auditing system and method are disclosed. The system and method may be used to simultaneously monitor, audit, and manage online, text-based chat interactions between a plurality of customer service representatives and a plurality of users. Chat streams are monitored through the use of flags that may be customized based on the preferences of the system operators. The system and method may also audit chat interactions through data collection and through a dashboard that aggregates and analyzes key performance indicators. A supervisor's dashboard may also be utilized to manage and oversee the chat interactions of a plurality of customer service representatives.

### CROSS-REFERENCE TO RELATED APPLICATIONS

This application claims priority under 35 U.S.C. §119 to U.S. Provisional Application No. 62/121,137 filed Feb. 26, 2015 and U.S. Provisional Application No. 62/078,019 filed Nov. 11, 2014, the entire disclosures of which are hereby incorporated by reference.

### BACKGROUND

As the Internet has become ubiquitous in daily life, customer interactions increasingly occur as online chats rather than telephone conversations. Proper management of online customer service resources has consequently become paramount to businesses. Negative customer reviews of online interactions can result in a substantial, negative impact on the company's finances and reputation. However, because customer service is a labor-intensive industry, failure at any stage of management can create a cascade of negative consequences that conventional methods fail to adequately address.

Online customer service and management is comprised of three primary components: ticket management, call management, and online chat management. The most challenging to supervise of these components is online chat management, in which customer service representatives (“CSRs”) engage in online, text-based chats with users. This form of customer service is challenging to supervise because a limited number of supervisors must monitor real-time customer service interactions between representatives and users. This task is compounded by the fact that each customer service representative is engaged in multiple, simultaneous online chats. No system exists in the prior art that allows for simultaneous, real-time monitoring and auditing of multiple online chat interactions. No system exists in the prior art that allows for simultaneous, real-time monitoring and auditing of multiple online chat interactions for multiple agents.

### SUMMARY

In order to overcome these and other disadvantages in the related art, there is provided a multi-chat monitoring and auditing system and method. This system and method solves the foregoing problems through a web-based system that can be used to simultaneously monitor, audit, and manage online, text-based chat interactions between a plurality of customer service representative and users. The system disclosed thus allows a limited number of supervisors to oversee and intervene in multiple online chat interactions between representatives and users through a graphic, dynamically updating dashboard in which the chat streams appear as widgets—dynamically updating applications or software modules that run within the graphic user interface. That functionality offers supervisors the opportunity to passively monitor online chat streams, actively intervene, and also train and audit customer service representatives. As used in this disclosure, the term “supervisor,” broadly encompasses any personnel who have a need to monitor, audit, and/or train customer service representatives in their online chat interactions with users.

Online chat interactions have quickly become one of the dominant forms of communication between customers and customer service representatives. A number of stand-alone online chat applications are practiced in the art, such as Google Chat, Apple iMessage, and Facebook Messenger. Further, most companies with an online presence rely on proprietary, integrated online chat applications to facilitate communications with customers. Examples of prior art online chat applications include Lent et al., U.S. Pat. No. 7,346,576, Weisberg, U.S. Pat. No. 7,861,176 and Singh et al., U.S. Pat. No. 8,762,862. In those online chat applications, communications between parties on different networked computers are mediated through a server utilizing standard Internet communication protocols, such as HTTP. However, while methods and apparatuses used to implement basic online chat applications are known in the art, there is a distinct lack of online chat application technology for enabling a single or small number of individuals to efficiently, simultaneously monitor multiple online chat interactions in real-time, while analyzing and auditing such chat interactions for customer service representatives. Those missing functionalities prevent existing online chat applications from operating efficiently as a primary point of communication with customers. As described herein, the present invention incorporates such features and is designed to be integrated into preexisting online chat applications and hardware or to operate as an independent chat application.

The monitoring of online, text-based chat streams is enabled through the creation of flags: words or terms used in chats, responsiveness time, customer data, or other data of interest appearing in a chat stream. Those flags can be designated by system architects, supervisors, or customer service representatives. Once a flag is created in the system, a graphic representation of the flag will appear on the supervisor's dashboard and optionally, the customer service representative's chat screen. Flags may be color-coded or otherwise marked to categorize importance. A customer service representative can also activate a flag at any time to attract the attention of a supervisor. The supervisor's dashboard, which shows all of the active chat streams of his customer service representatives, will graphically notify the supervisor of the flag or dynamically bring forward the affected chat screen. Once the flagged issue is resolved, the associated flag can be removed from the chat stream and the supervisor dashboard, and the supervisor dashboard will revert to real-time monitoring of customer service representative interactions with users.

The system is also capable of collecting and tabulating chat interaction data for customer service representatives. The supervisor's chat dashboard allows a supervisor to coach a representative on any chat, actively participate in the chat stream, or take control of a chat by removing the representative. The chat streams on the supervisor's dashboard, which appear as widgets, also collect metrics on representatives, such as service level, first contact resolution, customer satisfaction scores, average talk time, and unresponsive/unavailable time. The dashboard also aggregates key performance indicators for representatives, including customer satisfaction scores, handle time, representative utilization, wrap time, times a representative is unavailable, and the average speed of response to a user's request for chat. These capabilities of the invention provide summarized data at both the micro and macro levels that can be used to audit customer service performance and train low performing customer service representatives.

The present invention is therefore unique in that it has the ability to simultaneously monitor numerous online chat interactions while also aggregating metrics for training and auditing purposes. This technology has many applications in industries that have intensive customer engagement or at enterprises that require or utilize call centers.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1 is a diagram of an exemplary embodiment of the system of the present invention, illustrating the typical hardware used in its implementation;

FIG. 2A is an illustration, as contemplated by an exemplary embodiment of the invention, of an online chat graphic user interface as it appears to a customer service representative or customer;

FIG. 2B is an illustration, as contemplated by an exemplary embodiment of the invention, of an online chat graphic user interface displaying a screen available to a customer service representative;

FIG. 3 is an illustration, as contemplated by an exemplary embodiment of the invention, of an online chat graphic user interface as it appears to a supervisor and/or a customer service representative;

FIG. 4A is an illustrative flow chart of a representative process through which a request to chat with a customer service representative is sent;

FIG. 4B is an illustrative flow chart of a process by which the supervisor monitors, comments, and may take control of an ongoing chat between a customer and a customer service representative; and

FIG. 5 is a flow chart of an exemplary software pathway utilizing the hardware of FIG. 1, through which the method of the claimed invention is implemented.

### DETAILED DESCRIPTION OF THE INVENTION

Reference to the drawings illustrating various views of exemplary embodiments of the present invention is now made. In the drawings and the description of the drawings herein, certain terminology is used for convenience only and is not to be taken as limiting the embodiments of the present invention. Furthermore, in the drawings and the description below, like numerals indicate like elements throughout.

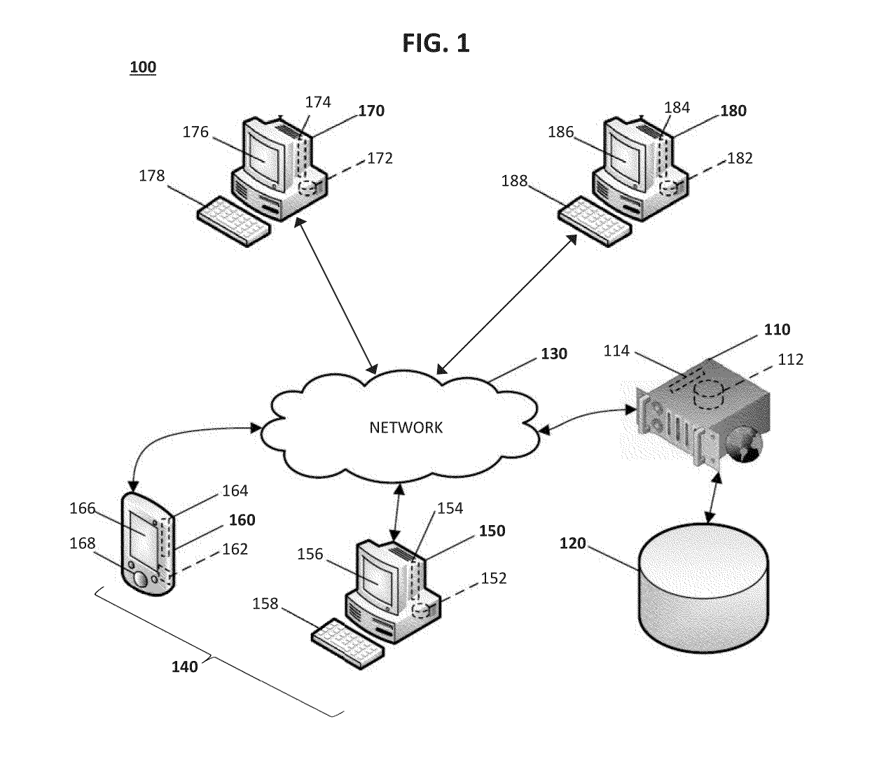

FIG. 1 is an overview of the hardware used to implement the system and process of multi-chat monitoring and auditing. The system 100 is comprised of one or more servers 110 and one or more databases 120 connected to a plurality of remote customer computer systems 140, such as one or more personal systems 150 and one or more mobile computer systems 160, via a network 130. Via that network 130, a plurality of customer representative computers (“CSR computers”) 170 and supervisor computers 180 are also connected to the servers 110 and databases 120.

The servers 110 of FIG. 1 are further comprised of an internal storage device 112 and a processor 114. The servers 110 may be any suitable computing device including, for example, an application server and a web server which hosts websites accessible by the remote computer systems 140. The databases 120 may be internal to any of the servers 110, in which case they may be stored on the internal storage device 112, or may be external to the server 110, in which case it may be stored on an external non-transitory computer-readable storage medium, such as an external hard disk array or solid-state memory. The databases 120 may be stored on a single device or multiple devices. The servers 110 and the databases 120 of the invention perform such tasks as processing requests to chat, storing relevant customer data, and providing that data as requested. The network 130 may include any combination of the internet, cellular networks, wide area networks (WAN), local area networks (LAN), etc. Communication via the network 130 may be realized by wired and/or wireless connections. A remote computer system 140 may be any suitable electronic device configured to send and/or receive data via the network 130. A remote computer system 140 may be, for example, a network-connected computing device such as a personal computer, a notebook computer, a smartphone, a personal digital assistant (PDA), or a tablet. The remote personal computer systems 150 may further be comprised of an internal storage device 152, a processor 154, output devices 156, and input devices 158. The remote mobile computer systems 160 may further be comprised of an internal storage device 162, a processor 164, output devices 166, and input devices 168.

On the other side of the network, a plurality of CSR computers 170 and supervisor computers 180 are connected through the network 130 to the servers 110 and the databases 120. It is through that connection that the CSR computers 170 and supervisor computers 180 are able to establish two-way communications with remote computer systems 140. Similar to remote computer systems 140, both CSR computers 170 and supervisor computers 180 may be, for example, network-connected computing devices such as a personal computer, a notebook computer, a smartphone, a personal digital assistant (PDA), or a tablet. The CSR computers 170 may further be comprised of an internal storage device 172, a processor 174, output devices 176, and input devices 178. The supervisor computers 180 may further be comprised of an internal storage device 182, a processor 184, output devices 186, and input devices 188.

An internal storage device 112, 152, 162, 172, and/or 182 may be non-transitory computer-readable storage mediums, such as hard disks or solid-state memory, for storing software instructions that, when executed by a processor 114, 154, 164, 174, or 184 carry out relevant portions of the features described herein. A processor 114, 154, 164, 174, or 184 may include a central processing unit (CPU), a graphics processing unit (GPU), etc. A processor 114, 154, 164, 174, or 184 may be realized as a single semiconductor chip or more than one chip. An output device 156, 166, 176 and/or 186 may include a display, speakers, external ports, etc. A display may be any suitable device configured to output visible light, such as a liquid crystal display (LCD), a light emitting polymer displays (LPD), a light emitting diode (LED), an organic light emitting diode (OLED), etc. The input devices 158, 168, 178 and/or 188 may include keyboards, mice, trackballs, still or video cameras, touchpads, etc. A touchpad may be overlaid or integrated with a display to form a touch-sensitive display or touchscreen.

The system 100 may be used by a single user at the remote computer 140 or by a plurality of users at remote computers 140 simultaneously. The system 100 may be realized by software instructions accessible to and executed by the server 110 and/or downloaded and executed by the remote computing system 140, the CSR computers 170, and/or the supervisor computers 180. As used herein, the term “users” and “customers” are equivalent and may refer to individuals, organizations, or entities in control of remote computer systems 140. The system 100, and more particularly the server 110, operates an online chat application as known in the prior art and discussed above. The present invention may be integrated into that online chat application, but may also run as a separate module, as long as it adds the novel functionalities discussed herein.

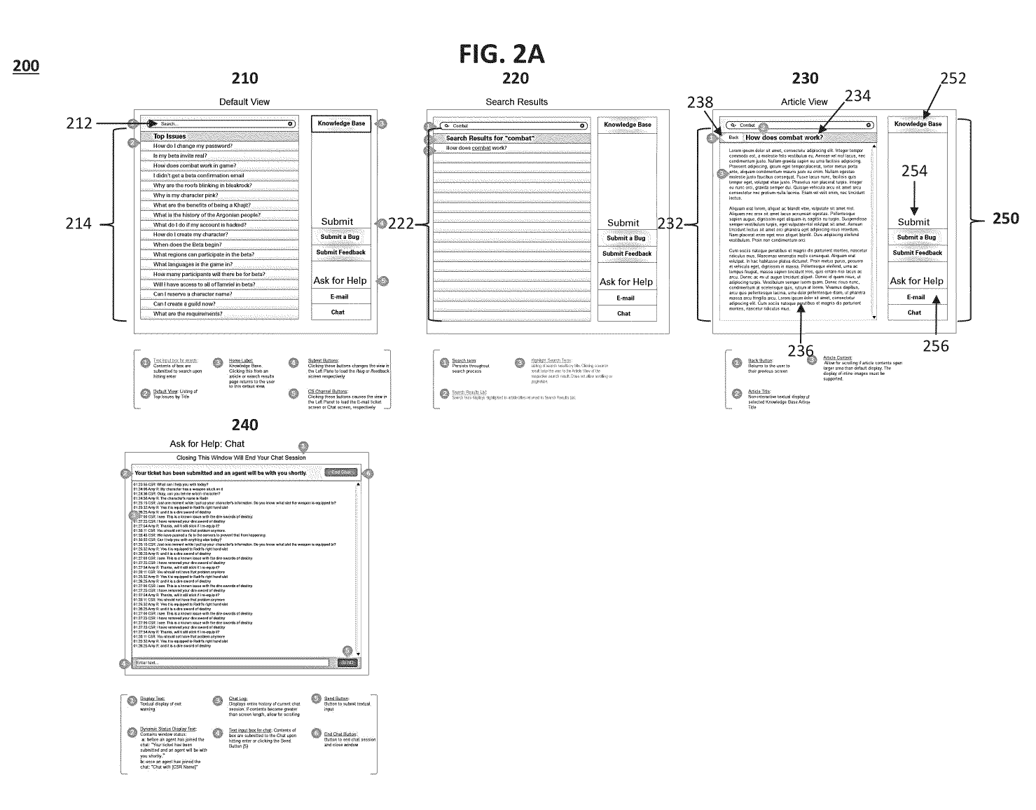

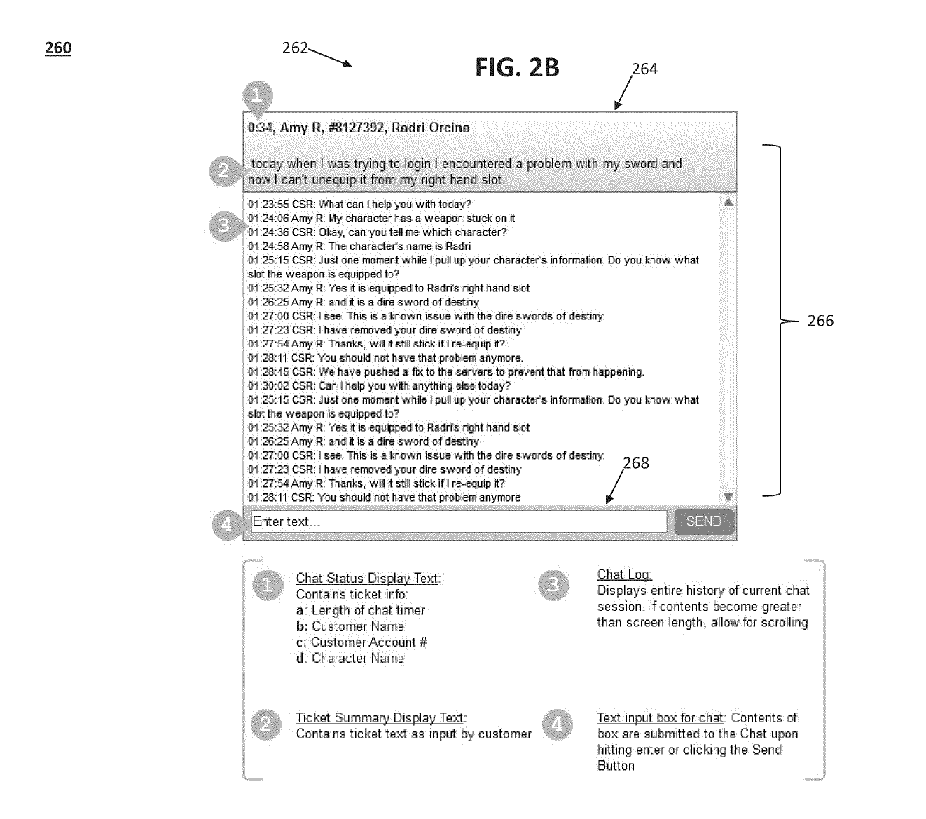

One aspect of the realization of the system 100 is depicted in FIG. 2A, which depicts an exemplary illustration of the various screens that can be accessed from the general graphic user interface (“GUI”) 200 of the system. This general GUI 200 is accessible to the customer service representative, the supervisor, and/or the customer. The general GUI 200 may be comprised of the Default View 210, the Search Results View 220, the Article View 230, and the Ask for Help Chat Screen 240. The Side Tab 250 appears as a panel in all views of the general GUI 200. In the Default View 210, the customer service representative, the supervisor, and/or the customer is provided with a Text Input Box 212 to initiate topic searches, the Top Issues Tabs 214 that lists common topics that can be selected to provide more information and the Side Tab 250. The Side Tab may be further comprised of a Knowledge Base button 252, which acts to return the customer service representative to the Default View 210, the Submit buttons 254, which are used to submit feedback or software performance issues, and the Ask For Help buttons 256, which can be used to request a chat with a customer service representative, either as a real-time chat or by email, by clicking the associated button. The Search Results View 220 is similar to the Default View 210, with the exception that the Top Issues Tabs 214 are replaced by Search Results List 222, which shows the results of searches queried through the Text Input Box 212. Upon clicking on one of the results in the Search Results List 222, the customer service representative, the supervisor, and/or the customer arrives at the Article View 230, which displays the Article 232, comprised of the Article Title 234, the Article Content 236, and a Back button 238, used to return to the Search Results View 220. The last screen, the Ask for Help Chat Screen 240, may be reached by clicking on the Ask for Help chat button 256 in any of the previously discussed screens 210, 220, or 230. The general GUI 200 may also appear within a commercially known web browser such as Microsoft Internet Explorer or Google Chrome, or as an embedded or pull-up window running as an integrated part of proprietary software, as long as the general GUI's 200 screens maintain the functionalities described herein.

FIG. 2B is a depiction an additional screen of the general GUI 200. This screen specifically appears to a customer service representative. It is this CSR GUI 260 screen that appears on the output device 176 of a CSR computer 170 when a request to chat is initiated from a remote computer system 140 using an analogous GUI on the remote computer system 140. The CSR computer 170 receives multiple chat requests, which may appear one at a time, as shown here, or as separate tabs on the general GUI 200. The servers 110 route the requests to chat to CSR computers 170 optimally, ensuring that CSR computers 170 receive such requests evenly and no single CSR computer 170 is overwhelmed by requests. The CSR GUI 260 screen is comprised of the Chat Status Display Text 262, the Ticket Summary Display Text 264, the Chat Log 266, and the Text Input Box 268. The Chat Status Display Text 262 displays the length of an ongoing online chat, the customer's name, the customer's account information, such as account number or customer number, and other identifying information, such as a character name alias or username. The Ticket Summary Display Text 264 dynamically updates to display the status of the request and the reason for the chat request, if the customer has chosen to provide one. The Chat Log 266 is a live, dynamically updating, time-stamped chat that displays the conversation between all parties involved in the online chat. The Text Input Box 268 allows the customer service representative to enter text and submit that text to the Chat Log 266. The customer service representative has access, at all times, to the other screens in the general GUI 200, as shown in FIG. 2A, which allow him to search for potential answers to customer chat requests for help.

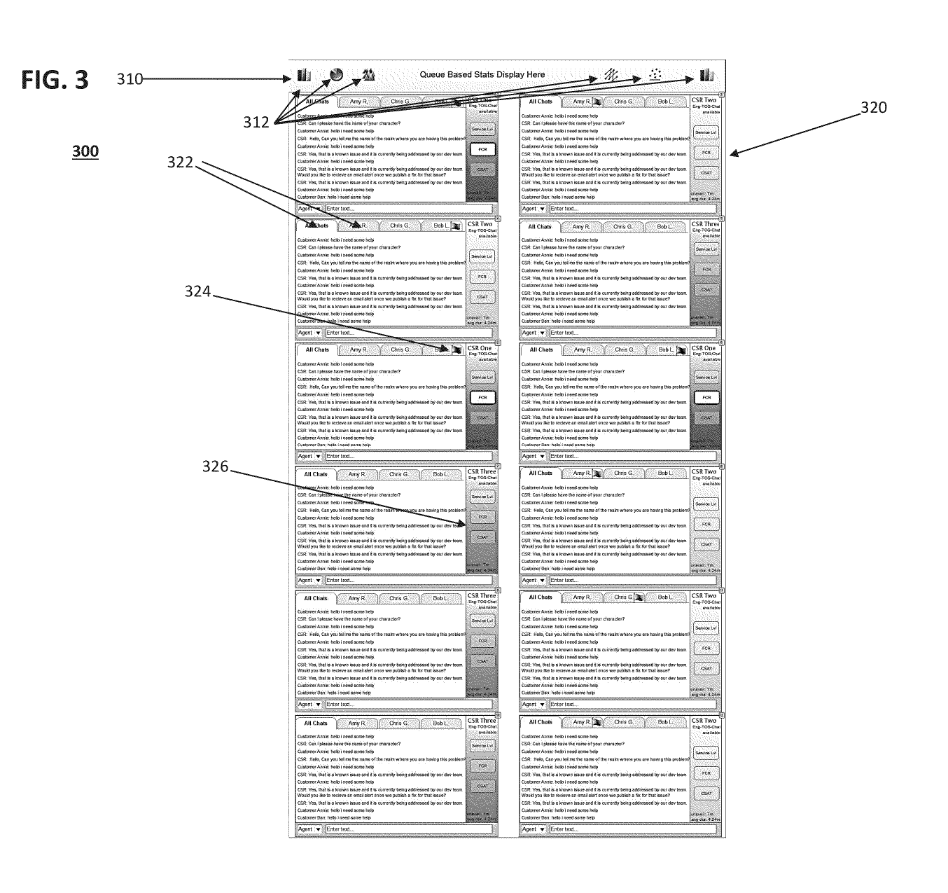

In FIG. 3, the general GUI 200 is depicted as it appears to a supervisor, in the form of Supervisor GUI 300. As a single supervisor computer 180 monitors a plurality of CSR computers 170, the general GUI 200 as it appears to a supervisor differs from the screens visible to a customer service representative. The Supervisor GUI 300 displays multiple, dynamically updating widgets simultaneously as a dashboard, along with metrics and auditing functionality. By contrast, the general GUI 200, as visible to a customer service representative, may display ongoing chat streams as the plurality of widgets shown in FIG. 3, without the metrics and auditing functionality, or as multiple, separate windows. Those widgets on the customer service representative's general GUI 200 may appear as a plurality of CSR GUI 260 screens.

Each of the plurality of widgets on the supervisor computer 180 is designed to monitor a plurality of CSR computer 170 online chats with customers. The Supervisor GUI 300 therefore may be comprised of a Statistics Toolbar 310 and a plurality of widgets 320. A CSR computer 170 in which widgets 320 have been implemented will be substantially similar, but lack the Statistics Toolbar 310 of the supervisor computer 180. The Statistics Toolbar is further comprised of a plurality of Metrics Buttons 312. Those Metrics Buttons 312 display data about customer service interactions in tabular and graphical forms, including but not limited to bar graphs, line charts, pie charts. and scatter plots. Those key performance indicators are collected in real time from online chats, compiling such customer service statistics such as response time, unresponsive time, number of issues escalated to supervisors, number of issues successfully resolved, positive comments from customers, customer satisfaction scores, average talk times, and flags (types and quantity). Key performance indicator data is stored on the databases 120 and retrieved by the Supervisor GUI 300 as needed from the server 110. That key performance indicator data may be associated with specific customers or in relation to each customer service representative. Parameters for the analysis of such metrics data may be predetermined and integrated into the software of the invention or may allow the supervisor computer 180 to select specific parameters to graphically or tabularly display over any time period through the Supervisor GUI 300.

Each widget 320 on the supervisor dashboard may be further comprised of Chat Tabs 322, flags 324, and a Flag Detail Bar 326. Chat Tabs 322, flags 324, and a Flag Detail Bar 326 may also appear on the general GUI 200 of a CSR computer 170 in certain embodiments of the invention implementing the use of widgets 320 for CSR computers 170. The Chat Tabs 322 are set to the “All Chats” tab by default. In that setting, a supervisor can monitor all active chats. A supervisor can also click on other Chat Tabs 322 to access specific ongoing chat streams. Additionally, each of the widgets 320 on the supervisor dashboard may automatically bring the Chat Tab 322 corresponding to the current active chat for each of the customer service representatives being monitored. Real-time monitoring of online, text-based chat streams by supervisors is further enabled through the creation of flags 324: customer identity, words or terms used in chats, responsiveness time, customer data, or other data of interest appearing in a chat stream. The graphical representation of a flag 324 is associated with the Chat Tab 322 to which it is related. Those flags 324 can be designated by system architects, supervisors, customer service representatives, or based on preexisting logic rules. Once a flag is created in the system, a graphic representation of the flag 324 will appear on the supervisor's dashboard and optionally, the customer service representative's chat screen. Flags 324 may be color-coded or otherwise marked to categorize importance or significance by users of the system or automatically, based on preexisting logic rules in the software. In that particular embodiment, the flags 324 are shown as color-coded, with yellow signifying an issue and red signifying a high priority issue. A customer service representative can also activate a flag 324 at any time to attract the attention of a supervisor. When a flag 324 is active, the dashboard widget will graphically notify the supervisor of the flag or dynamically bring forward the affected chat screen. Once the flagged issue is resolved, the associated flag 324 can be removed from the chat stream and the supervisor dashboard, and the supervisor dashboard will revert to real-time monitoring of customer service representative interactions with users. Notifications of active flags 324 may also be sent to other customer service representatives within the system, based on their subject matter expertise in resolving certain types of flags 324 or to all customer service representatives, such that any one of them can intervene in the ongoing chat to provide a resolution to the request for help. Other customer service representatives may also intervene in unflagged chats upon invitation from the primary customer service representative.

The Flag Detail Bar 326 provides additional information about flagged or unflagged online chats between customer service representatives and customers. The Flag Detail Bar 326, independent of flags 324, is color-coded or otherwise visibly associated with the chat it is describing. In that particular embodiment, the Flag Detail Bar 326 is color-coded, based on the satisfaction or failure of criteria depending on key performance indicators. The Flag Detail Bar 326 may also include specific information about the selected chat, such as the identity of the customer service representative, the duration of the chat, the responsiveness of the customer service representative, and the average time spent with a customer in a chat.

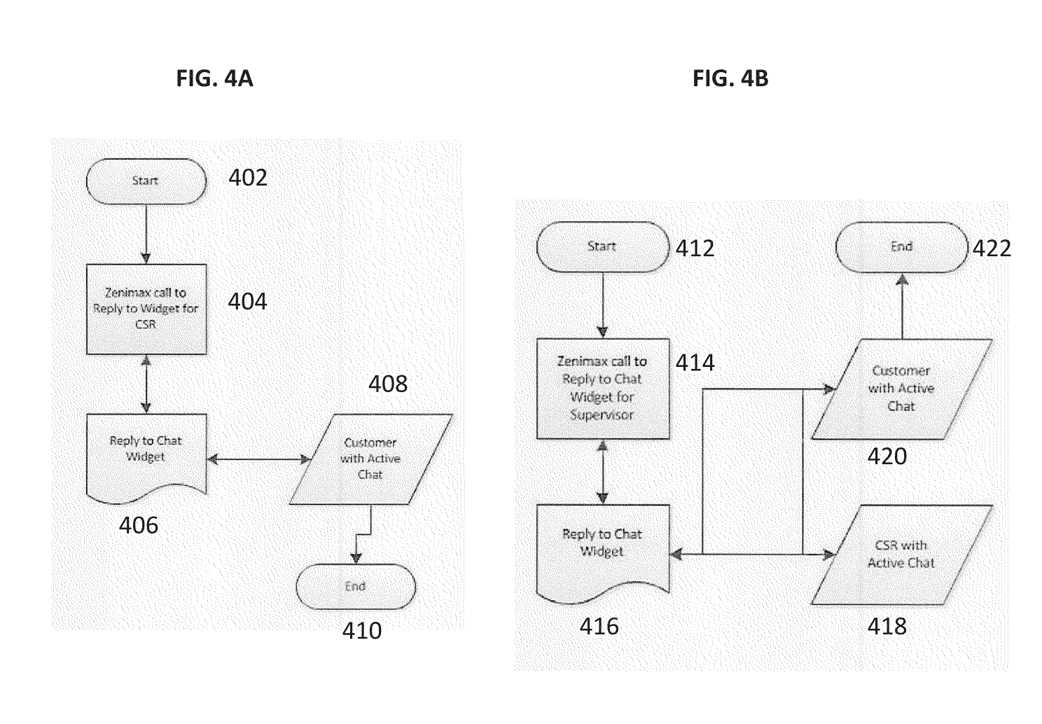

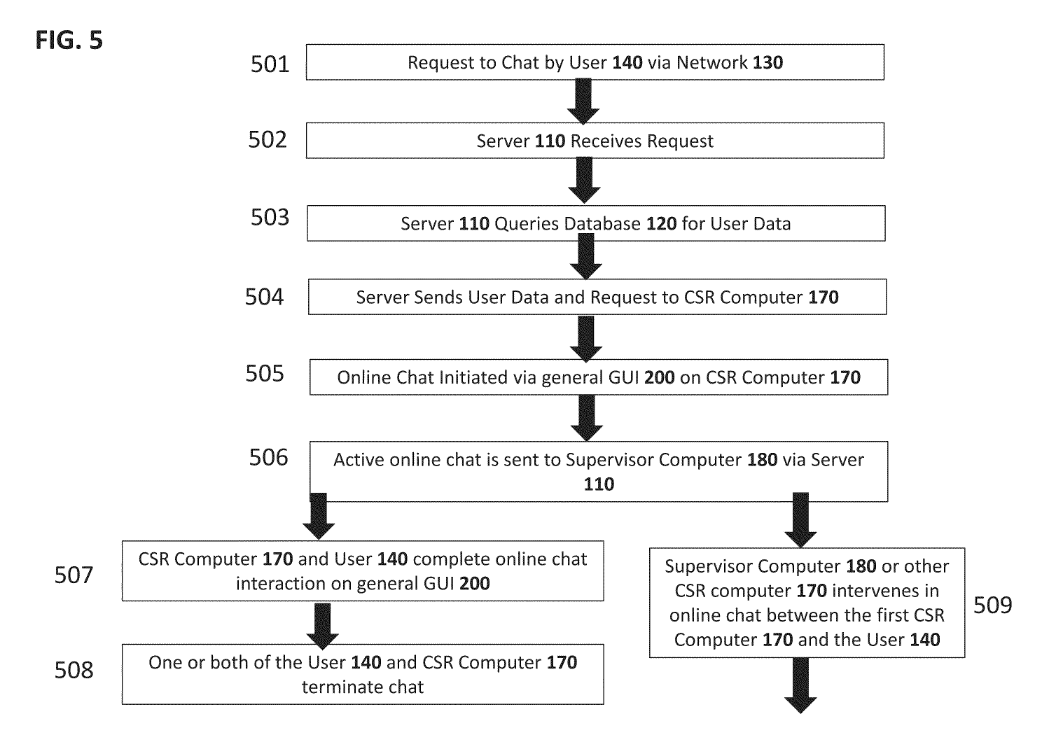

FIG. 4A is illustrative of a representative process through which a request to chat with a customer service representative is sent. That flow chart begins with “Start,” 402 where the customer initiates a request to chat. At “Zenimax call to Reply to Widget for CSR,” 404 the request to chat appears on the CSR computer 170 via the general GUI 200 of the system. That request to chat may take the form of the CSR GUI 260 screen. The customer service representative can then activate the online chat at the CSR computer 170 by typing a response, as shown by “Reply to Chat Widget” 406. At that time, the chat window between the customer and the customer service representative is active, as shown by “Customer with Active Chat” 408. The chat ends when the customer logs off, at “End” 410.

FIG. 4B is illustrative of a representative process by which the supervisor monitors, comments, and may take control of an ongoing chat between a customer and a customer service representative. A supervisor's dashboard is activated at “Start.” At “Zenimax call to Reply to Chat Widget for Supervisor,” a supervisor is notified, preferably by a flag 324. At that point, a supervisor is monitoring ongoing chats, which appear in the dashboard as widgets 320. At “Reply to Chat Widget,” a supervisor may choose to (1) participate in the ongoing chat between the customer and the customer service representative, shown as “CSR with Active Chat,” or (2) remove the customer service representative and take control of the chat with the customer, shown as “Customer with Active Chat.” In that representative embodiment, the chat ends when the customer is satisfied and logs off the chat, shown at “End”.

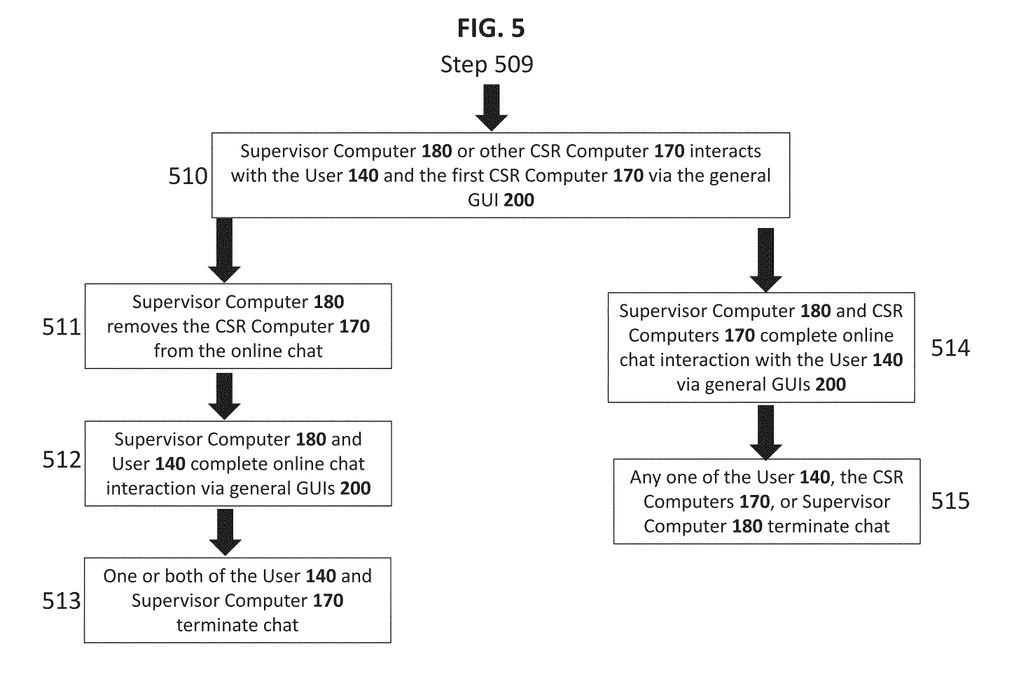

FIG. 5 is illustrative of the method by which the system implements the invention. At step 501, a request to chat is sent by a customer in control of a remote computer 140 through the network 130 by which the system is connected. At step 502, the server 110 receives the request to chat from the user 140 and, at step 503, queries the plurality of databases 120 to which it is linked, retrieving relevant information about the user 140 that may be passed to the CSR computer 170. At step 504, the CSR computer 170 receives the request to chat and relevant user data from the server 110, and it is displayed to the customer service representative, as illustrated in FIG. 4A. At step 505, the customer service representative activates the chat with the user by accepting the request, and the online chat is initiated on the general GUI 200 of the CSR computer 170. At step 506, upon the initiation of the chat, the data comprising the ongoing chat stream is sent to the supervisor computer 180 via the server 110, where it is monitored, as described in FIG. 4B. A copy of the chat is also stored in the server 110 for metrics and auditing purposes, which may be accessed from the Statistics Toolbar 310 of the supervisor dashboard. At that point, the software may follow one of two alternate paths: at step 507, the CSR computer 170 and the user 140 may reach a successful conclusion, which results in step 508, the termination of the online chat. Alternately, the software pathway may proceed to step 509, in which the supervisor computer 180, monitoring the online chat, decides to intervene, for any reason, including the presence of a flag 324 or a lack of knowledge or responsiveness from the customer service representative. As illustrated in FIG. 3, however, flags 324 or a general request for help from the primary representative may also allow any other CSR computer 170 to intervene in an ongoing chat.

In cases where the software pathway proceeds to step 509, the supervisor computer or other CSR computer 170 can participate in the online chat. At any point, the supervisor computer may choose and remove any CSR computer 170 from the online chat, thereby taking control of the interaction with the customer. In step 510, the supervisor computer 180 or other CSR computer 170, via the general GUI 200 dashboard, begins interaction with the user 140 and the first CSR computer 170. As explained in FIG. 3, while a supervisor computer 180 is aware of the ongoing chat interaction at all times, another CSR computer 170 becomes aware of the chat and intervenes only through the use of flags 324.

In the case of the supervisor computer 180 removing the CSR computer 170 from the chat, the software pathway proceeds to step 511. Once the CSR computer 170 is removed from the chat by the supervisor computer 180 at step 511, the supervisor computer 180 and the user 140 complete their online chat via the general GUI 200 running on their respective computers at step 512. Finally, at step 513, one or both of the supervisor computer 180 or the user 140 terminate the online chat. Alternately, following step 510, the supervisor computer 180 and/or another CSR computer 170 may choose to participate in the online chat without removing the CSR computer, as shown in step 514. In that case, all parties participate in the online chat with the user 140. The online chat terminates at step 515, in which any one of the user 140, the CSR computers 170, or the supervisor computer 180 ends the online chat via their respective general GUIs 200.

While preferred embodiments have been set forth above, those skilled in the art who have reviewed the present disclosure will readily appreciate that other embodiments can be realized within the scope of the invention. For example, disclosures of specific numbers of hardware components, software modules and the like are illustrative rather than limiting. Therefore, the present invention should be construed as limited only by the appended claims.

1. A non-transitory computer-readable storage medium that stores a multi-chat monitoring and auditing program that, when executed, causes a processor to:
operate an online chat application that creates a graphic, dynamically updating interface for communications between a plurality of users and a representative;
monitor online chats on said chat application for a plurality of predetermined flags;
notify a supervisor or other representatives of a flagged chat via a graphic, dynamically updating dashboard or chat application; and
grant other representatives and the supervisor access to both flagged and unflagged real-time online chat between the representative and the user.

2. The computer-readable storage medium of claim 1, wherein the multi-chat monitoring and auditing program further collects and graphically or tabularly summarizes on the dashboard application metrics and key performance indicators related to real-time online chats.

3. The computer-readable storage medium of claim 2, wherein the dashboard application metrics and key performance indicators collected and displayed include service level, first contact resolution, customer satisfaction scores, average talk time, and unresponsive/unavailable time.

4. The computer-readable storage medium of claim 1, wherein the graphic, dynamically updating dashboard or chat application may appear as a window in a web browser, as one or more widgets, or as a window within proprietary software.

5. The computer-readable storage medium of claim 1, wherein the predetermined flags include words or terms used in chats, responsiveness time, customer data, or other data of interest appearing in a chat stream.

6. The computer-readable storage medium of claim 1, wherein the supervisor access to real-time online chats includes the ability to actively participate in the chat and/or remove any representative from the chat.

7. The computer-readable storage medium of claim 1, wherein other representatives' access to real-time online chats includes the ability to actively participate in the chat.

8. A method for multi-chat monitoring and auditing comprising:
receiving at an online chat application a plurality of requests from users to chat with a representative;
operating on said online chat application a plurality of real-time online chat interfaces between a representative and a user;
monitoring real-time online chats between users and representatives for a plurality of predetermined flags;
notifying a supervisor or another representative of a flagged chat via a graphic, dynamically updating dashboard application; and
granting other representatives and the supervisor access to both flagged and unflagged real-time online chats between representatives and users.

9. The method of claim 8, further comprising collecting metrics and key performance indicators and graphically or tabularly summarizing said metrics and key performance indicators on the dashboard application.

10. The method of claim 9, wherein the dashboard application metrics and key performance indicators collected and displayed include service level, first contact resolution, customer satisfaction scores, average talk time, and unresponsive/unavailable time.

11. The method of claim 8, wherein the graphic, dynamically updating dashboard or chat application may appear as a window in a web browser, as one or more widgets, or as a window within proprietary software.

12. The method of claim 8, wherein the predetermined flags include customer identity, words or terms used in chats, responsiveness time, customer data, or other data of interest appearing in a chat stream.

13. The computer-readable storage medium of claim 8, wherein the graphic, dynamically updating dashboard or chat application may appear as a window in a web browser, as one or more widgets, or as a window within proprietary software.

14. The computer-readable storage medium of claim 8, wherein the predetermined flags include customer identity, words or terms used in chats, responsiveness time, customer data, or other data of interest appearing in a chat stream.

15. The computer-readable storage medium of claim 8, wherein the supervisor access to real-time online chats includes the ability to actively participate in the chat and/or remove any representative from the chat.

16. The computer-readable storage medium of claim 8, wherein other representatives' access to real-time online chats includes the ability to actively participate in the chat.
